(19) United States
(12) Patent Application Publication
(10) Pub. No.: US 2008/0310157 A1
(43) Pub. Date: Dec. 18, 2008

(54) Illuminating device

(75) Inventors: Yueh-Hsun Yang, Tainan (TW); Chen-Kang Hsu, Tainan (TW)

Correspondence Address: PILLSBURY WINTHROP SHAW PITTMAN, LLP, P.O. BOX 10500, MCLEAN, VA, 22102, US

(73) Assignee: T.Y.C. BROTHER INDUSTRIAL CO., LTD., Tainan (TW)

(21) Appl. No.: 11/808,668

(22) Filed: Jun. 12, 2007

(51) Int. Cl. F21V 21/00; F21V 7/00

(52) U.S. Cl. 362/235; 362/249

(57) ABSTRACT

An illuminating device includes an illuminating unit including a light source that is mounted on a base board and that has a first number of first light emitting diodes and a second number of second light emitting diodes. Each of the first and second light emitting diodes of the light source has a light-emitting area. The light-emitting area of each first light emitting diode has a maximum horizontal width, and a maximum vertical width smaller than the maximum horizontal width of the light-emitting area of a corresponding first light emitting diode. The light-emitting area of each second light emitting diode has a maximum vertical width, and a maximum horizontal width not greater than the maximum vertical width of the light-emitting area of a corresponding second light emitting diode.

### BACKGROUND OF THE INVENTION

1. Field of the Invention

The invention relates to an illuminating device, more particularly to an illuminating device having light emitting diodes as a light source.

2. Description of the Related Art

FIG. 1 illustrates a conventional illuminating device 1 that includes an illuminating unit 12 mounted in a reflector 11, and a transparent cap 13 mounted on a front end of the reflector 11.

Referring further to FIG. 2, the illuminating unit 12 includes a rectangular circuit board 121, and a plurality of light emitting diodes 122 mounted on the circuit board 121 and arranged in a 2×6 array. Each light emitting diode 122 is of low power consumption, and has a circular central light-emitting area 123.

In a luminous intensity test associated with the ECE (Economic Commission of Europe) Rule R-38, light rays radiating from the light emitting diodes 122 are reflected by the reflector 11 and are projected onto a screen (not shown) spaced apart from the illuminating unit 12 by a predetermined distance (e.g., 3.16 m), so as to form a projecting luminous area on the screen. As a result, luminous intensities in the projecting luminous area on the screen can be detected to obtain a test result as shown in FIG. 3. According to the ECE Rule R-38, in a situation where an illuminating device is used as a rear fog lamp of a vehicle, luminous intensities in a rhombus enclosed by imaginary lines of FIG. 3 are required to be within a range of 75 cd˜300 cd, and the luminous intensities along a horizontal diagonal line of the rhombus are required to be within a range of 150 cd˜300 cd.

From the test result of FIG. 3, the conventional illuminating device 1 cannot meet luminous intensity requirements for the ECE Rule R-38, in particular, for those along the horizontal diagonal line of the rhombus. In order to meet the luminous intensity requirements for the ECE Rule R-38, it is required to increase the number of the light emitting diodes 122 or to use light emitting diodes with higher power consumption, thereby resulting in higher costs.

### SUMMARY OF THE INVENTION

Therefore, the object of the present invention is to provide an illuminating device that can overcome the aforesaid drawbacks of the prior art.

According to the present invention, an illuminating device comprises an illuminating unit including a base board, and a light source mounted on the base board and having a first number of first light emitting diodes and a second number of second light emitting diodes. Each of the first and second light emitting diodes of the light source has a light-emitting area.

The light-emitting area of each of the first light emitting diodes of the light source has a maximum horizontal width, and a maximum vertical width smaller than the maximum horizontal width of the light-emitting area of a corresponding one of the first light emitting diodes. The light-emitting area of each of the second light emitting diodes of the light source has a maximum vertical width, and a maximum horizontal width not greater than the maximum vertical width of the light-emitting area of a corresponding one of the second light emitting diodes.

### BRIEF DESCRIPTION OF THE DRAWINGS

Other features and advantages of the present invention will become apparent in the following detailed description of the preferred embodiments with reference to the accompanying drawings, of which:

FIG. 1 is a partly sectional schematic view of a conventional illuminating device;

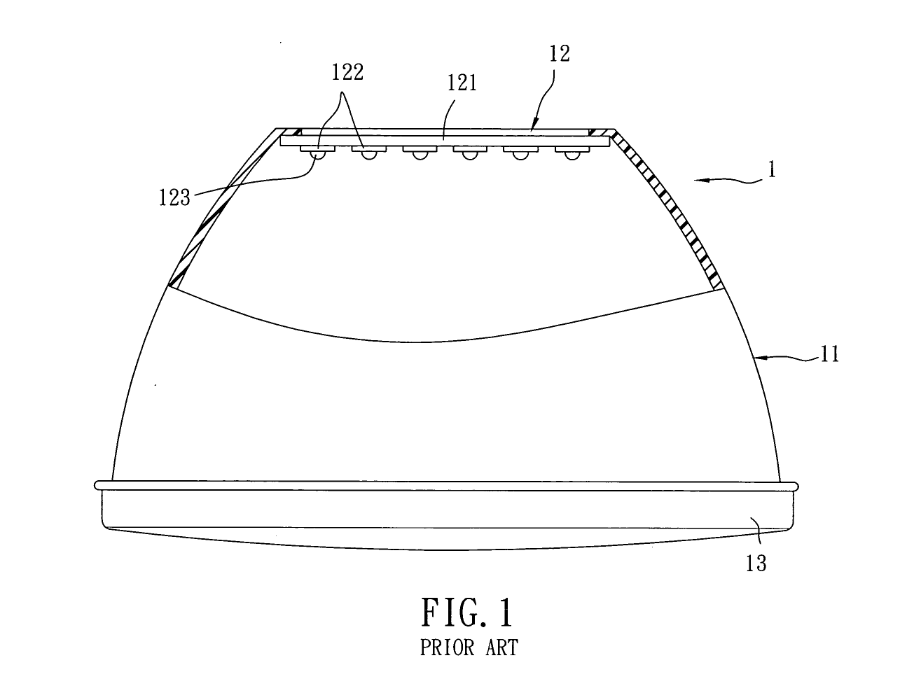

FIG. 2 is a schematic front view of an illuminating unit of the conventional illuminating device;

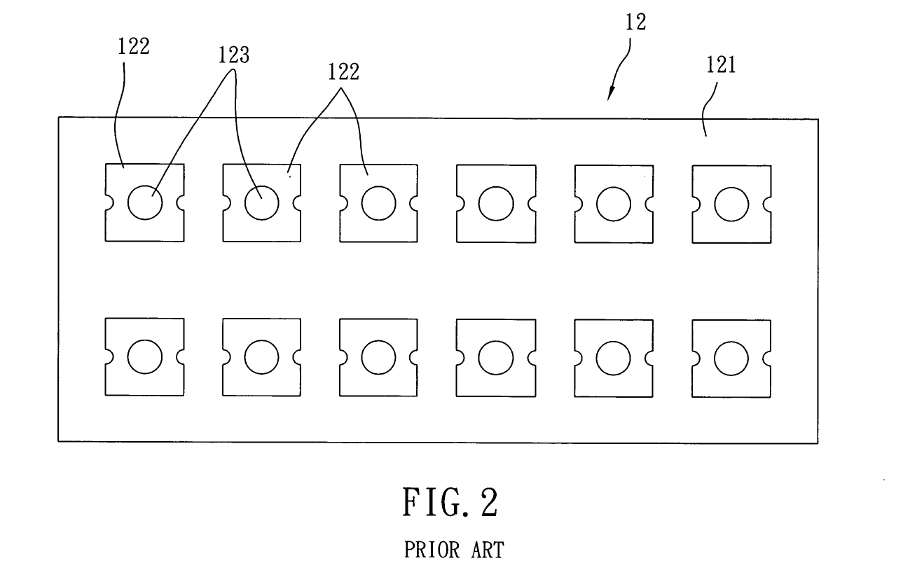

FIG. 3 is a contour chart of luminous intensities of the conventional illuminating device;

FIG. 4 is a partly sectional schematic view showing the first preferred embodiment of an illuminating device according to the present invention;

FIG. 5 is a schematic front view showing an illuminating unit of the first preferred embodiment;

FIG. 6 is a contour chart of luminous intensities of the first preferred embodiment;

FIG. 7 is a schematic front view showing an illuminating unit of a second preferred embodiment of an illuminating device according to the present invention;

FIG. 8 is a contour chart of luminous intensities of the second preferred embodiment;

FIG. 9 is a schematic front view showing an illuminating unit of a third preferred embodiment of an illuminating device according to the present invention; and

FIG. 10 is a contour chart of luminous intensities of the third preferred embodiment.

### DETAILED DESCRIPTION OF THE PREFERRED EMBODIMENTS

Before the present invention is described in greater detail, it should be noted that like elements are denoted by the same reference numerals throughout the disclosure.

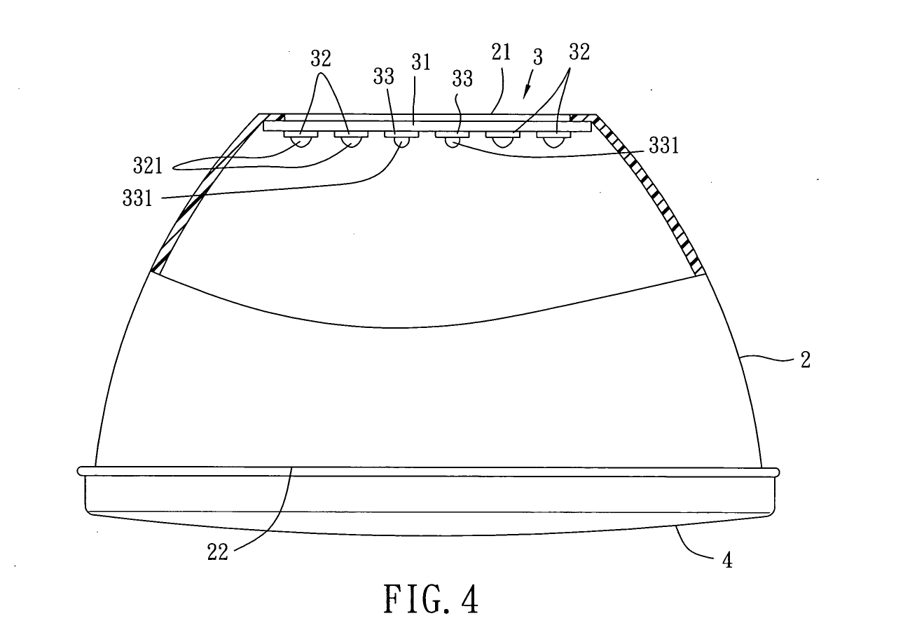

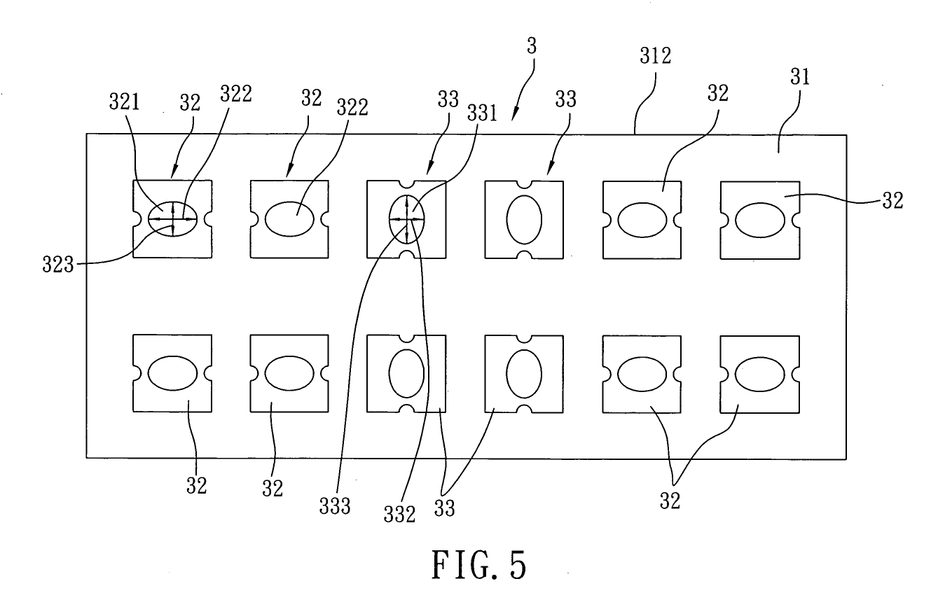

Referring to FIGS. 4 and 5, the first preferred embodiment of an illuminating device according to the present invention is shown to include a reflector 2, an illuminating unit 3, and a transparent cap 4.

The reflector 2 has front and rear open sides 22, 21. The transparent cap 4 is mounted on the front open side 22 of the reflector 2.

The illuminating unit 3 is disposed in the reflector 2, and includes a rectangular base board 31, such as a circuit board, mounted on the rear open side 21 of the reflector 2, and a light source mounted on the base board 31 for radiating light rays that are subsequently reflected by the reflector 2. The light source has a first number of first light emitting diodes 32 and a second number of second light emitting diodes 33. Each of the first and second light emitting diodes 32, 33 has a light-emitting area 321, 331. In this embodiment, the first number is equal to 8, and the second number is equal to 4. The second light emitting diodes 33 are arranged in an array, and are disposed on a middle of the base board 31, while the first light emitting diodes 32 are divided into two groups, each of which has four of the first light emitting diodes 32 arranged in an array. The second light emitting diodes 33 are disposed between the groups of the first light emitting diodes 32. It is noted that the light-emitting area 321, 331 of each of the first and second light emitting diodes 32, 33 is elliptic. The light-emitting area 321 of each of the first light emitting diodes 32 has a maximum horizontal width 322, and a maximum vertical width 323 smaller than the maximum horizontal width 322 of a corresponding one of the first light emitting diodes 32. On the other hand, the light-emitting area 331 of each of the second light emitting diodes 33 has a maximum vertical width 333, and a maximum horizontal width 332 smaller than the maximum vertical width 333 of a corresponding one of the second light emitting diodes 33.

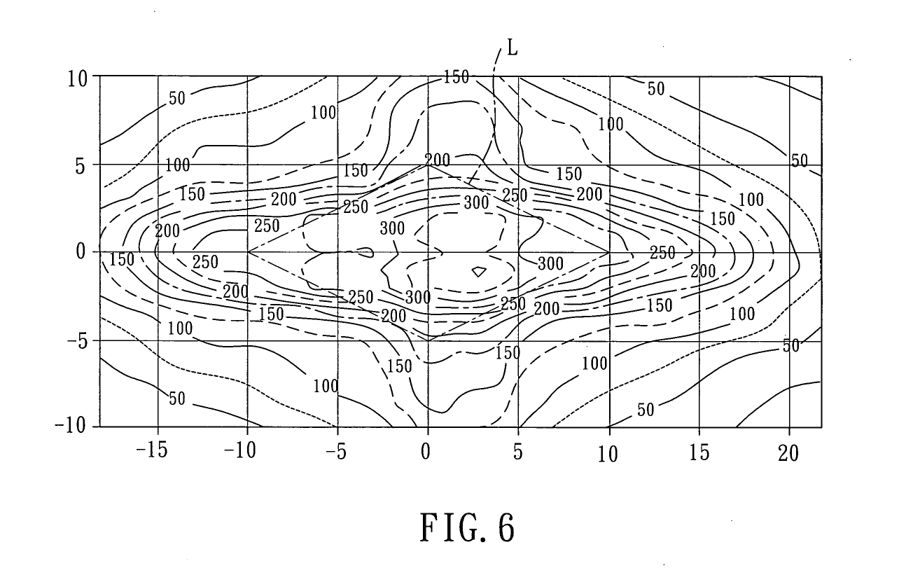

Under the same test as that in the prior art, a contour chart of luminous intensities of the illustrating device can be obtained as shown FIG. 6. From the test result of FIG. 6, the illuminating device of the present invention can meet luminous intensity requirements for ECE Rule R-38. In other words, the luminous intensities of the illuminating device along a horizontal diagonal line of a rhombus (L) enclosed by imaginary lines are within a range of 150 cd˜300 cd, and the luminous intensities of the illuminating device within the rhombus (L) are within a range of 75 cd˜300 cd. It is noted that the illuminating device of the present invention meets luminous intensity requirements for SAE (Society of Automotive Engineers) Rule as well.

In such a configuration, even if the first and second light emitting diodes 32, 33 are operated by a low driving current, the first light emitting diodes 32 having the elliptic light-emitting areas 321 enhance luminous intensities particularly in a horizontal direction, and the second light emitting diodes 33 having the elliptic light-emitting areas 331 enhance luminous intensities particularly in a vertical direction. Hence, the illuminating device of the present invention can be used as a rear fog lamp for a vehicle with relatively low power consumption.

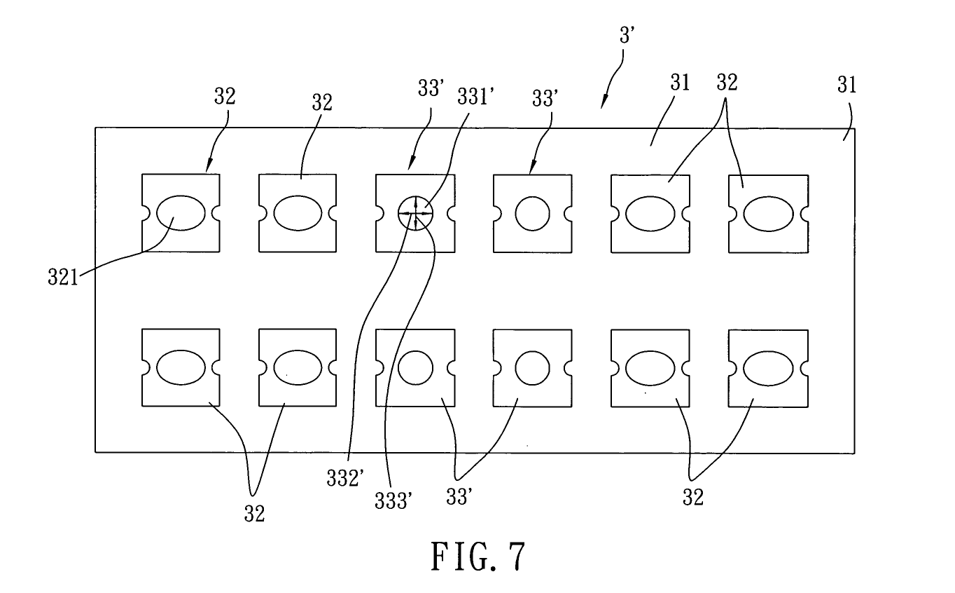

FIG. 7 illustrates the second preferred embodiment of an illuminating device according to this invention, which is a modification of the first preferred embodiment. In this embodiment, the light-emitting area 331′ of each second light emitting diode 33′ is circular. Hence, for the light-emitting area 331′ of each second light emitting diodes 33′, the maximum horizontal width 332′ is equal to the maximum vertical width 333′.

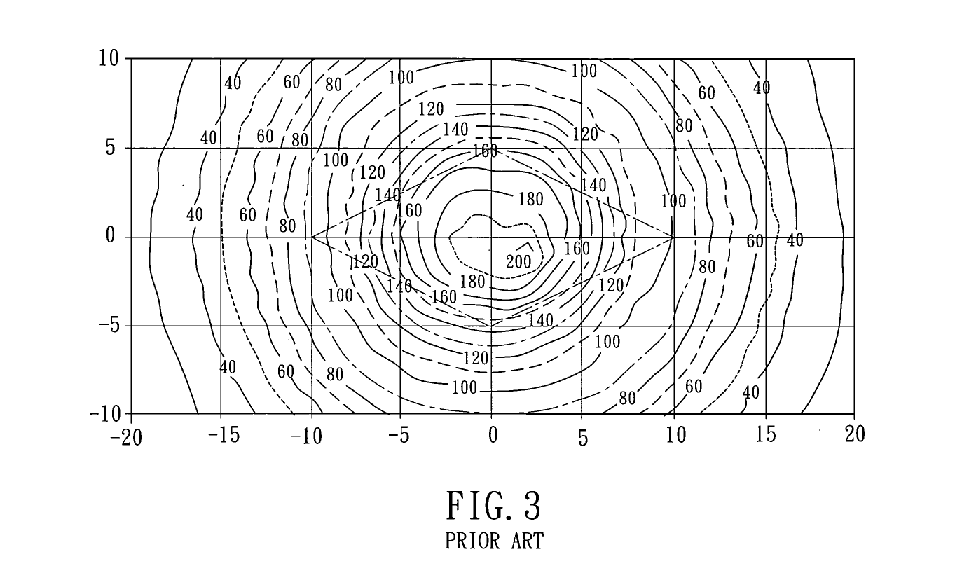

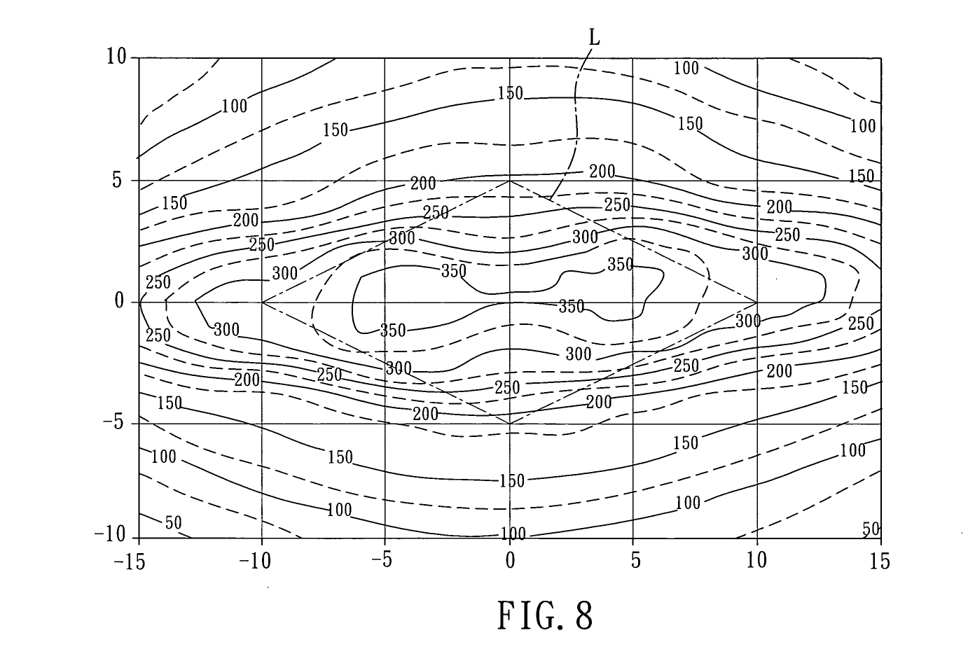

FIG. 8 shows a test result of the second preferred embodiment under the same test as that in the prior art. From the test result of FIG. 8, although the second light emitting diodes 33′ have the circular light-emitting areas 331′, the luminous intensities along the vertical diagonal line of the rhombus (L) are apparently higher than those of the prior art shown in FIG. 3, and, on the other hand, the luminous intensities along the horizontal diagonal line of the rhombus (L) are apparently higher than those of the first preferred embodiment shown in FIG. 6 because of a slightly increased driving current applied to the illuminating unit 3′.

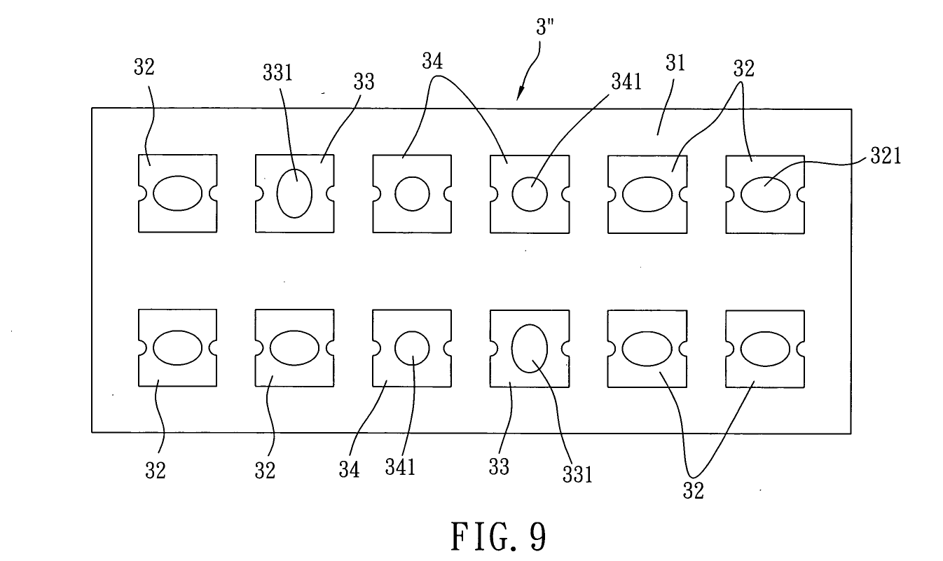

FIG. 9 illustrates the third preferred embodiment of an illuminating device according to this invention, which is a modification of the first preferred embodiment.

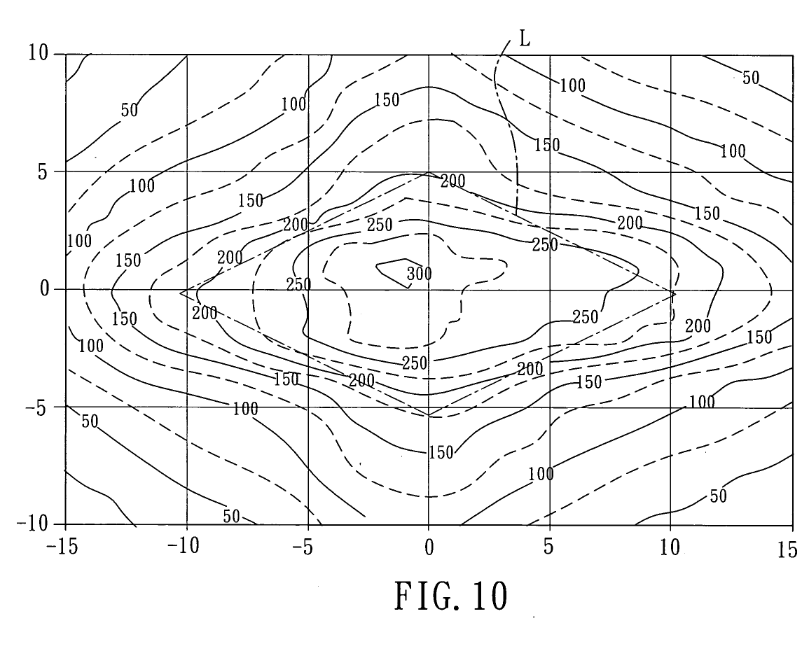

In this embodiment, the first number of the first light emitting diodes 32 is equal to 7, and the second number of the second light emitting diodes 33 is 2. The light source further includes a third number of third light emitting diodes 34, wherein the third number is equal to 3. Each third light emitting diode 34 has a circular light-emitting area 341. All of the first, second and third light emitting diodes 32, 33, 34 are arranged in a 2×6 array. From the test result shown in FIG. 10, the third preferred embodiment can meet the luminous intensity requirements for the ECE Rule R-38.

While the present invention has been described in connection with what are considered the most practical and preferred embodiments, it is understood that this invention is not limited to the disclosed embodiments but is intended to cover various arrangements included within the spirit and scope of the broadest interpretation so as to encompass all such modifications and equivalent arrangements.

We claim:

1. An illuminating device comprising:
an illuminating unit including a base board, and a light source mounted on said base board and having a first number of first light emitting diodes and a second number of second light emitting diodes, each of said first and second light emitting diodes of said light source having a light-emitting area;
wherein said light-emitting area of each of said first light emitting diodes of said light source has a maximum horizontal width, and a maximum vertical width smaller than the maximum horizontal width of said light-emitting area of a corresponding one of said first light emitting diodes, said light-emitting area of each of said second light emitting diodes of said light source having a maximum vertical width, and a maximum horizontal width not greater than the maximum vertical width of said light-emitting area of a corresponding one of said second light emitting diodes.

2. The illuminating device as claimed in claim 1, wherein said light-emitting area of each of said first light emitting diodes of said light source is elliptic.

3. The illuminating device as claimed in claim 2, wherein said light-emitting area of each of said second light emitting diodes of said light source is elliptic.

4. The illuminating device as claimed in claim 3, wherein the first number is equal to 8, and the second number is equal to 4, said second light emitting diodes being arranged in an array and being disposed on a middle of said base board, said first light emitting diodes being divided into two groups, each of which has four of said first light emitting diodes arranged in an array, said second light emitting diodes being disposed between said groups of said first light emitting diodes.

5. The illuminating device as claimed in claim 3, wherein said light source further includes a third number of third light emitting diodes, each of which has a circular light-emitting area.

6. The illuminating device as claimed in claim 5, wherein the first number is equal to 7, the second number is equal to 2, and the third number is equal to 3.

7. The illuminating device as claimed in claim 2, wherein said light-emitting area of each of said second light emitting diodes of said light source is circular.

8. The illuminating device as claimed in claim 7, wherein the first number is equal to 8, and the second number is equal to 4, said second light emitting diodes being arranged in an array and being disposed on a middle of said base board, said first light emitting diodes being divided into two groups, each of which has four of said first light emitting diodes arranged in an array, said second light emitting diodes being disposed between said groups.

9. The illuminating device as claimed in claim 1, further comprising a reflector mounted with said illuminating unit therein and having a front open end, and a transparent cap mounted on said front open end of said reflector.
